(19) United States
(12) Patent Application Publication
(10) Pub. No.: US 2004/0254999 A1
(43) Pub. Date: Dec. 16, 2004

(54) SYSTEM FOR PROVIDING CONTENT TO MULTIPLE USERS

(75) Inventors: Douglas A. Bulleit, Atlanta, GA (US); Barbara J. Roden, Atlanta, GA (US); Stephen J. Bye, Atlanta, GA (US)

Correspondence Address: CANTOR COLBURN LLP, 55 GRIFFIN ROAD SOUTH, BLOOMFIELD, CT, 06002, US

(73) Assignee: BELLSOUTH INTELLECTUAL PROPERTY CORPORATION, Wilmington, DE (US)

(21) Appl. No.: 10/605,928

(22) Filed: Nov. 6, 2003

Related U.S. Application Data
(60) Provisional application No. 60/478,688, filed on Jun. 13, 2003.

(51) Int. Cl. G06F 15/16

(52) U.S. Cl. 709/207

(57) ABSTRACT

A content distribution system including a content source and a plurality of consumer networks including a controller and a consumer storage device. A distribution network couples the content source to the controllers of the consumer networks. The distribution network includes network storage devices and network processors. A grid computing platform includes the controllers, the network processors, the consumer storage devices and the network storage devices. The grid computing platform provides storage of the content across network storage devices and consumer storage devices and distribution of the content to one or more of the consumer networks.

### CROSS REFERENCE TO RELATED APPLICATIONS

This application claims the benefit of U.S. provisional patent application Ser. No. 60/478,688, filed Jun. 13, 2003, the entire contents of which are incorporated herein by reference.

### BACKGROUND OF INVENTION

The present invention relates generally to communications services and in particular to providing content to multiple users. Systems exist for distributing content to users such as broadcast television, cable television, pay-per-view, etc. In such systems, the content provider dictates when content is available and the user may view the content at the scheduled time. Devices such as video cassette recorders (VCRs) and digital video recorders (DVRs) such as the TiVo system allow users to time-shift content and view the content at a time different from the broadcast time.

There is increasing desire by users for content on demand. In such systems, users can immediately obtain multimedia (e.g., motion pictures). Such system must address features such as billing, security, quality, etc. Embodiments of the invention are related to a content distribution system addressing these, and other features, of multimedia distribution.

### SUMMARY OF THE INVENTION

Embodiments of the invention include a content distribution system including a content source and a plurality of consumer networks including a controller and a consumer storage device. A distribution network couples the content source to the controllers of the consumer networks. The distribution network includes network storage devices and network processors. A grid computing platform or other form of distributed resource management includes the controllers, the network processors, the consumer storage devices and the network storage devices. The grid computing platform provides storage of the content across network storage devices and consumer storage devices and distribution of the content to one or more of the consumer networks.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of an exemplary system for distributing content to multiple users.

FIG. 2 depicts an exemplary content distribution architecture.

FIG. 3 depicts an exemplary distribution network in embodiments of the invention.

FIG. 4 depicts an exemplary grid computing platform in embodiments of the invention.

FIG. 5 depicts an exemplary consumer network in embodiments of the invention.

### DETAILED DESCRIPTION

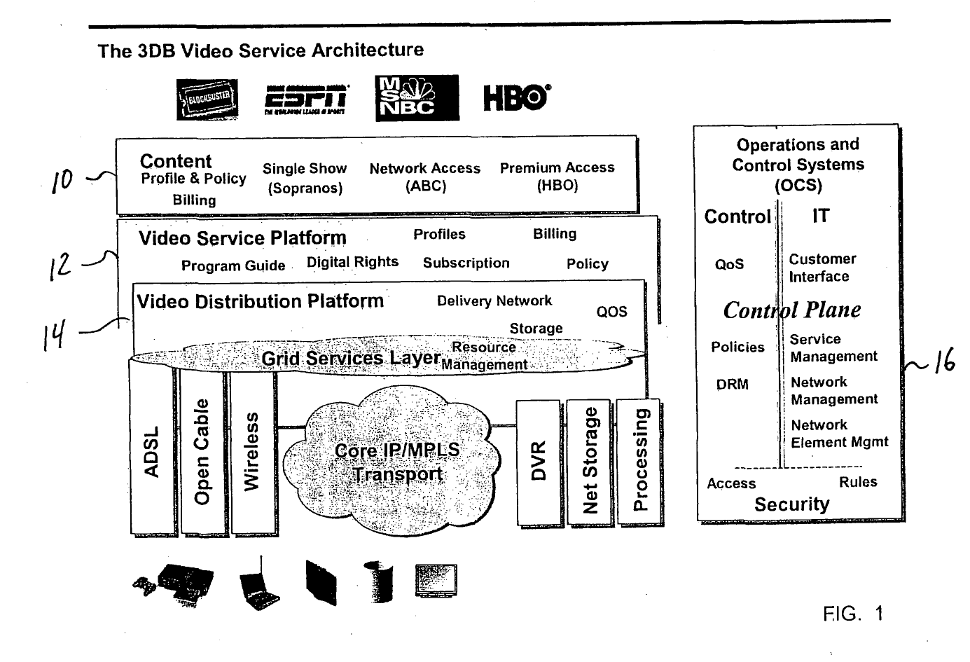

FIG. 1 is a block diagram of an exemplary architecture of a content distribution system for distributing content to multiple users. As shown in FIG. 1, content 10 from many sources is aggregated and distributed to many consumers based on profiles associated with the content and the consumer. The content 10 may be a variety of audio-visual multimedia, such as television programs, movies, consumer-generated content, audio, etc.

A video services platform 12 controls subscription management and billing functions. This layer supports a program guide, management of content, device and user profiles, digital rights and other security. The video services platform 12 provides measurement tools to assess network performance, accounting, billing, logging, and other service control functions. This layer of the content distribution system 10 may be implemented using processor-based network elements such as computers at a central office and/or distributed processor-based network elements.

A video distribution platform 14 manages aspects associated with delivering approved content to the end consumer. This includes management of resources such as bandwidth on the last mile loop, bandwidth within the edge and core network, content retrieval, caching policies and quality of service objectives. This layer of the content distribution system 10 may be implemented using processor-based network elements such as computers at a central office and/or distributed processor-based network elements.

A control layer 16 manages the end-end service including aspects of the underlying transport network, the underlying storage network, and the video services functions. This layer of the content distribution system 10 may be implemented using processor-based network elements such as computers at a central office and/or distributed processor-based network elements.

A program guide in the video service platform 12 allows the consumer to subscribe to and manage content 10. This includes identifying content that the consumer wishes to store based on particular shows or categories of interest. A simple intuitive interface supports content classification, searches, selections, etc. In addition to consumer-selected content, the service builds a profile of the consumer based on viewing patterns and preloads content that has a high likelihood of interest to the consumer.

The program guide interface also provides the consumer an interface into the billing system to allow the consumer to see charges associated with various content, current billing data, and account management.

Content 10 is managed through the relationships of a variety of profiles and policies defined within the content distribution system. The end consumer has a profile that defines the content that has been purchased by the consumer and additional content that may be purchased or perhaps specifically prevented. The content or programming also has a profile associated with it. This profile indicates the billing fees associated with the program and viewing rules such as number of times played, number of days available, etc. A device profile includes constraints on the display devices as some content may only be appropriate for devices capable of displaying digital broadcast quality video where other content can be displayed on lower quality devices.

The content distribution system manages to the intersection of the three profiles ensuring that the content is appropriate for the consumer, the consumer is willing to pay for the content, and that the content can be displayed on the consumer's viewing device. The content distribution system tracks the usage of the content and duration of the “rental” to ensure that the content owner is compensated.

In addition to managing the digital rights associated with the content, the video services layer 12 communicates with the video distribution layer 14 to ensure that storage and network QOS capabilities conform to agreements entered into with the content owner.

The control layer 16 provides support for the video distribution platform 14 and employs many support components found in telecommunications delivery networks today. The functions defined in the Telecommunications Management Network Architecture are defined by the FCAPS model and are applied and extended to support the video distribution platform 14.

One function provided by the control layer 16 is fault management. Fault management includes the functions required to identify and correct troubles within the content distribution system. This includes network outage reporting, service outage reporting, alarm surveillance, fault management, fault localization, restoration, automatic dispatch, and testing, as well as the processes and documentation associated with these functions.

Another function provided by the control layer 16 is configuration management. Configuration management includes network planning and engineering functions, installation and provisioning functions, service management and resource status. Most of the configuration management capabilities are found within a grid computing platform and focus on dynamic resource discovery and peer-to-peer resource negotiations. The grid computing platform is discussed in further detail herein.

Another function provided by the control layer 16 is account management. Account management focuses on collecting usage records, pricing strategies, billing and collections, and auditing. The content distribution system is capable of billing by the show, by premium packaged content, by network content, both for video-on-demand content and for subscription content. The content distribution system tracks data on the number of times the program was viewed the number of days the program is available, etc. Accounting is closely linked to digital rights and security management functions. The accounting function covers both the consumer's use of content as well as settlements with content owners.

Another function provided by the control layer 16 is performance management. Performance management includes performance quality assurance, performance monitoring, and performance management control. The content distribution system supports performance management on a number of levels within the service. At the most basic level, the across a consumer link (e.g., ADSL) is managed to control the quality of video delivery. This includes determining when to stream off-line video and the number of active video sessions that can be open. The content caching must be managed to ensure an optimal distribution of content to the consumer's storage device, the storage devices served out of the same central office, and other storage devices within the network.

Another function provided by the control layer 16 is security management. Security management secures both the content distribution network as well as the content. This function is tied to digital rights management. The content distribution system preserves rights of the content owners.

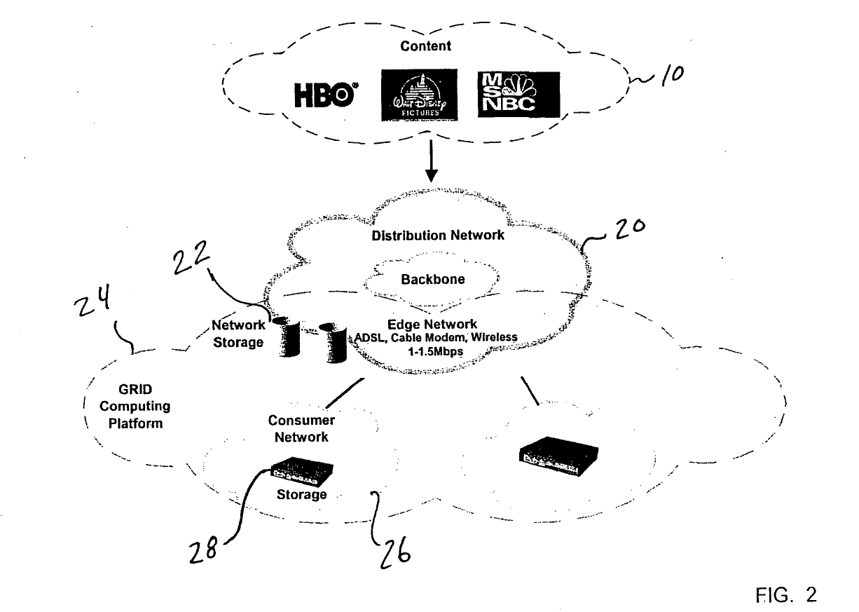

FIG. 2 depicts an exemplary video distribution architecture. The video distribution architecture includes the underlying network 20 and software infrastructure to support the video service platform 12 discussed with reference to FIG. 1. The major components of the architecture include the content 10, the distribution network 20 (backbone and access), the storage network 22, the grid computing platform 24, and a consumer network 26. It is understood that the consumer network 26 is not limited to residential locations but may be any end user of the content.

The content 10 is made available through a distribution agreement between the content distribution system provider and the content owner. There is a defined process for adding new content into the network and an associated profile including digital rights, subscription rules, quality of service (QOS), and billing rules. Content is stored within content provider storage 11, network storage 22 as well as on consumer storage devices (e.g., DVR) at the consumer sites.

The distribution network 20 includes the backbone and the edge network. A QOS capable network such as anMPLS core provides the backbone network for content distribution. The core network interfaces with a variety of access network and access network technologies. This includes ADSL networks as well as an open cable network, wireless DSL network, and other access networks as required.

The distributed storage architecture includes storage within the distribution network at network storage devices 22, perhaps at a centralized locations (e.g., central offices) as well as storage devices 28 at the consumers' sites (e.g., DVR devices). The storage network supports transmission of realtime video that is archived for future viewing and supports the transportation of non-realtime video between storage devices (e.g., consumer-to-consumer).

The grid computing platform 24 controls components of the distribution network. The grid computing platform 24 is provided by network elements executing grid applications. As described in further detail herein, the grid computing platform 24 is implemented using processor based network elements at a central office, at edges of the network, at the consumer location, etc. This grid applications software controls resources within the network including processing, bandwidth, and storage. The grid computing platform 24 provides the core applications platform for managing content and customer profiles including digital rights, subscriptions, billing, monitoring, etc.

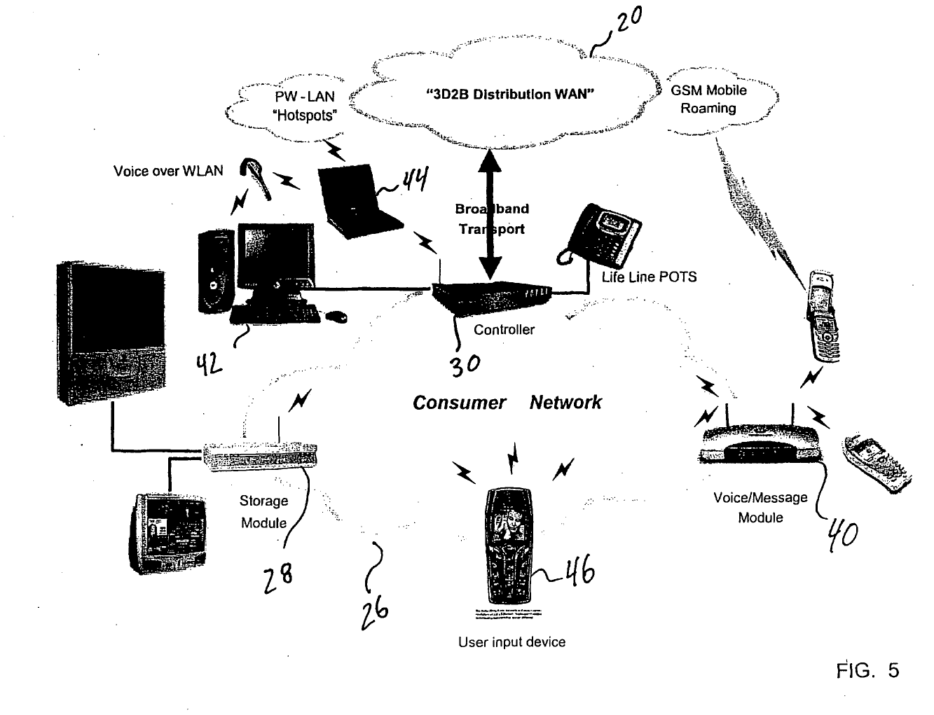

The consumer network 26 is the end user network that seamlessly unites all/any of the typical end-user's information appliances and devices as described in further detail with reference to FIG. 5. The consumer network 26 manages the receipt of content from the distribution network 20 and stores the content on a storage device 28 (e.g., DVR). The consumer network 26 may be based on a wireless networking standard such as 802.11 e.

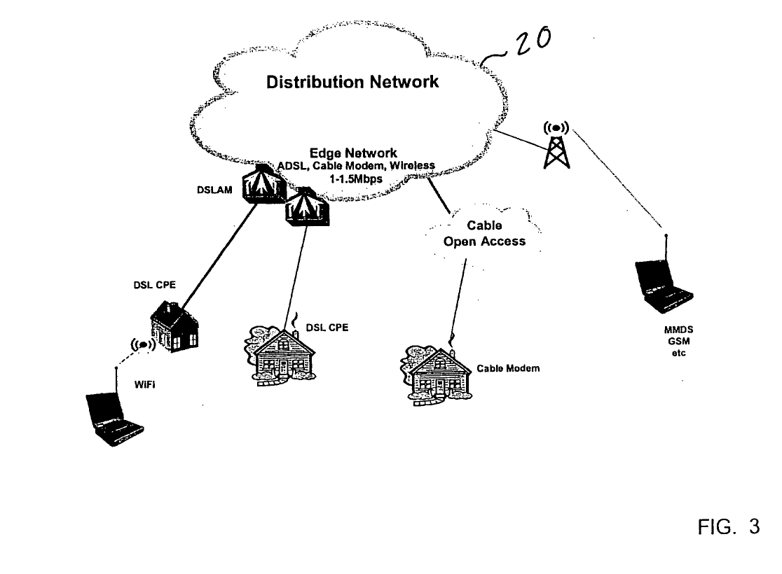

FIG. 3 depicts an exemplary distribution network 20 in an embodiment of the invention. The distribution network 20 provides for distributing content to a variety of consumers via a number of different channels. An ADSL link provides 1.5-3 Mbps downstream and 512 Kbps upstream. This allows 2-3 video streams to be delivered simultaneously over the downstream bandwidth. This may include a combination of actual realtime video and non-realtime programming that is being preloaded on a consumer storage device 28 (e.g., DVR). The upstream bandwidth is used to transfer stored programs from one consumer's storage device 28 to another consumer's storage device 28, preferably coupled to a common network element (e.g., the same central office). In addition, both the upstream and downstream links are used for management of the content distribution service.

As shown in FIG. 3, the distribution network 20 can also include other ADSL networks, open access cable, and/or a wireless DSL platform. The content distribution service may be offered over another ILEC's ADSL network. The content distribution service could be offered over cable modem access. The network operator derives value from the video service and the video revenue stream, not from the underlying access network. Further, the network owner may only need access to the underlying network rather than own the network outright.

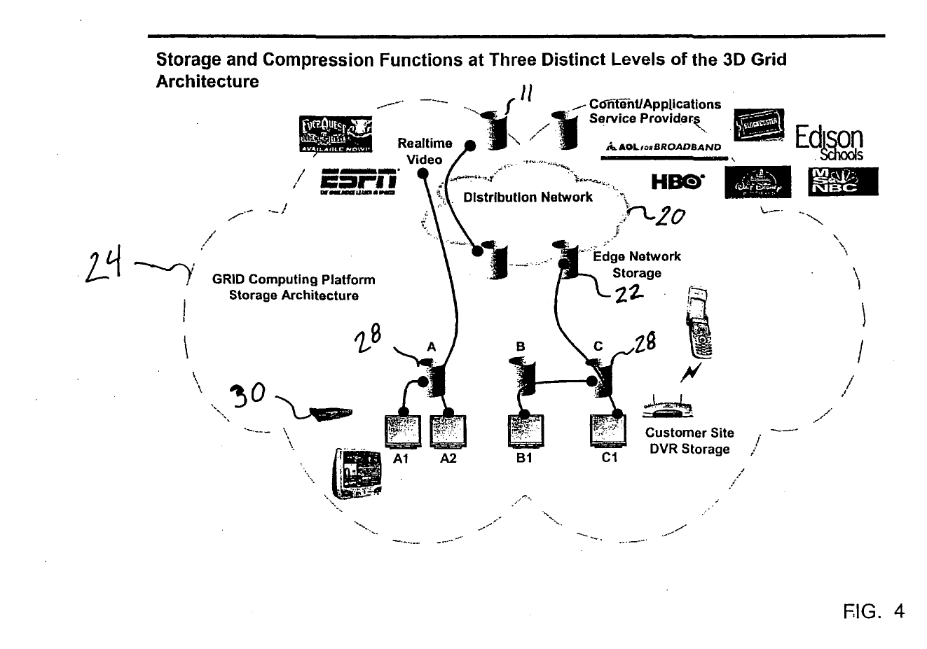

FIG. 4 depicts an exemplary grid computing platform 24 in an embodiment of the invention. The content distribution service platform is a very large scale distributed platform. The grid infrastructure is scaled to solve a number of issues: authentication, authorization, accounting, resource discovery, resource access, resource negotiation, compression/decompression, encoding/decoding, content caching, content discovery, content retrieval, quality of service, management mechanisms, and other challenges. The grid computing platform 24 monitors bandwidth consumption at the edge of the network 20 to determine whether an additional video stream can be delivered, to determine whether non-realtime content can be delivered to the consumer storage device 28, and whether the link can support upstream video delivery.

The grid computing platform 24 determines when and where to store non-realtime video. The grid computing platform 24 is implemented using distributed network elements such as controller 30 (e.g., set-top box), consumer storage devices 28 (which may be incorporated within controller 30), network storage devices 22 (e.g., at central office, data centers) and/or other network elements (e.g., processors at central office locations or other locations). processor-based network element(s) determine based on customer preference, customer viewing habits or other reasons when to store a video program on the consumer storage device 28. Processor-based network element(s) decide where to store content that is not resident on the user's local consumer storage device 28. The grid computing platform 24 understands the network relationship between users to optimize network resources when content must be distributed from one consumer's storage device 28 to another consumer's storage device 28.

The grid computing platform 24 manages storage transparently to the consumer. The consumer is aware of the content they currently subscribed to and additional content that they may subscribe to. The location of the content is transparent to the consumer. The consumer does not know and does not need to know if the content is on their local storage device 28 or being pulled from another storage device in the network. In FIG. 4, TV A1 pulls the program out of the resident DVR 28 while TV A2 displays realtime programming streamed over the network 20. TV B1 pulls content from another consumers DVR 28 while TV C1 pulls programming from a network resident storage device 22. Thus, content may be distributed from a variety of storage devices in a distributed network architecture.

The grid computing platform 24 also processes content using techniques such as compression or encoding. The distributed processor-based network elements perform compression/decompression. By using distributed processing, compression can be performed more rapidly thereby reducing the bandwidth requirements to the consumer. As processing power is increased through distributed computing, bandwidth requirements to the consumer are decreased as high bandwidth content (e.g., streaming video) can be decompressed in near realtime.

Compression can be broken down into a number of compression techniques such as spatial and temporal redundancy encoding and perceptual encoding. Temporal encoding focuses on identifying only those sections of video that change from frame to frame, sending the updates rather than the full frame. Periodically a full frame is sent to ensure video quality and to pick up scene changes. Human Perception encoding is focused on stripping out the content of a frame that the human eye cannot perceive. This includes reducing the number of colors, brightness, texture, etc. It also includes searching for repeating patterns that can be sent once and applied several times within a frame.

Video encoding standards have been led by the Motion Picture Expert Group (MPEG) which is heavily driven by the requirements of the content owners. MPEG-2 was standardized in 1994 for digital television. MPEG-2 specifies the decoder process not the encoding process, as a result, bandwidth requirements may vary by implementation. MPEG-2 coders typically operate in the 2-4 Mbps range. The MPEG-4 standard is the interactive coding standard for digital multimedia platforms. MPEG-4 part 4 encoding delivers an improvement over MPEG-2 and includes video extensions that allow additional encoding standards to be used as approved. The distributed network elements of the grid computing platform 24 handle compression/decompression and/or encoding/decoding of the content as needed to reduce bandwidth requirements on the distribution network 20.

FIG. 5 depicts an exemplary consumer network 26 in an embodiment of the invention. In one embodiment, the consumer network 26 is a residential home network, but similar networks may be employed in any setting where content is distributed. The consumer network 26 is preferably a wireless network that connects multiple devices using existing wireless network techniques (e.g., 802.11 g/e/i, 802.11 b, HPNA, Power Line Carrier, UWB). The controller 30 is coupled to the distribution network and serves as a gateway device between the consumer network 26 and the distribution network 20.

The consumer network 26 includes associated home devices such as: DVR, TV, PC, PDA, game consoles, telephone, etc. Content may be provided through controller 30 to the consumer's storage device 28. A voice/message module 40 provides for wireless telecommunications services. Voice data may also be distributed to a personal computer 42 or laptop 44. Thus, the consumer network 26 provides communication between devices as well as connecting the storage device 28 back to the distribution network 20 for distributing content to other consumers.

The consumer network 26 includes a handheld user input device 46 and associated navigating software to command and control voice, data and video applications. The consumer network 26 has a common control platform for managing devices on the consumer network 26. This includes the ability to navigate through the video programming guide. A simple and functional user interface is one aspect of the content distribution service. This interface promotes watching pre-loaded content thereby reducing the bandwidth across the content distribution network. The interface highlights the breadth of content available on demand to move the consumer away from valuing cable broadcast services based on the number of channels. The consumer selects content through a remote control. The interface must provide advanced flexible features such as pause, rewind, and fast forward that are not provided by the broadcasters without a CPE upgrade. The user input device 46 provides such features to guide the consumer through the program guide.

The systems and architectures discussed above provide a number of features. Distributed storage is achieved through network storage elements 22 within the distribution network (e.g., at a central office or a data center) and consumer's storage devices 28 (e.g., DVRs). These processor-based network elements execute distributed computing processes for determining where and when to store content on a consumer's storage device 28. Factors involved in the geographic-based content distribution include the location of the receiving storage device and network performance on available routes to the receiving storage device.

The content distribution system may use a number techniques to distribute content on the distribution network 20. For example, in order to compensate for reduced upload bandwidth from consumer storage devices 28 to the distribution network 20, video may be stored in sections on several consumer storage devices 28. When video needs to be distributed from the consumers' storage devices to another consumer, only a limited amount is required from each source. Alternatively, rather that store full content on a consumer storage device 28, store the first X minutes to get started then stream the rest in for viewing and storage.

The content distribution system also provides content management. The distributed network elements manage one content stream as many component streams (e.g., from multiple storage devices) and merge the component streams together to deliver content. To prevent piracy, video content may be stored locally on a consumer storage device 28 and the audio track streamed to the consumer upon viewing, but not stored. As described herein, content may be shared between consumer storage devices 28 in peer-to-peer system under the control of the network elements to prevent unauthorized uses.

The grid computing platform 24 provides a number of billing options including peer-to-peer distributed billing (e.g., billing consumers for content delivered from other consumers), interactive billing (e.g., pricing change based on adds watched or interactive adds to ensure they were watched), billing linked to network delivery performance (e.g., QOS such as realtime delivery or store-then-view delivery). The grid computing platform 24 also provides services such as profile management (content profiles, consumer profiles and device profiles). The distributed processing of the grid computing platform also allows installation of additional network elements through plug and play configuration and insertion into the grid.

The distribution network may be a digital subscriber line network (DSL, ADSL, etc.) and provides a number of features. The DSL transmission may be mapped to single carrier modulation (SCM) format. Multiple Pair bonding may be used to provide distribution and management. The grid computing platform 24 interacts with the distribution network to modify DSL rate limiting, QOS, etc. The point-to-point nature of DSL may prevent eavesdropping piracy and may be used to track a particular user. Security techniques, such as entering a watermark per user, may be used to track access to content.

Additional security measures may be implemented to protect content and network data. One technique is to never store the entire content on a single consumer storage device 28 always stream one component (e.g., the audio track, or every X number of video frames). Network data, such as billing data, may be stored in a redundant distributed platform, with billing data stored in several places such as on consumer storage devices, network storage devices, etc.

As described above, the present invention can be embodied in the form of computer-implemented processes and apparatuses for practicing those processes. In an exemplary embodiment, the invention is embodied in computer program code executed by the server. The present invention may be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

1. A content distribution system comprising:
a content source;
a plurality of consumer networks including a controller and a consumer storage device;
a distribution network coupling said content source to said controller of said consumer networks, said distribution network including network storage devices and network processors;
a grid computing platform including said controllers, said network processors, said consumer storage devices and said network storage devices, said grid computing platform providing storage of said content across network storage devices and consumer storage devices and distribution of said content to one or more of said consumer networks.

2. The system of claim 1 wherein:
said grid computing platform compresses content prior to said distribution of said content to one of said consumer networks.

3. The system of claim 1 wherein:
said grid computing platform encodes content prior to said distribution of said content to one said consumer networks.

4. The system of claim 1 wherein:
one of said consumer networks specifies a quality of service, delivery of said content being billed in response to said quality of service.

5. The system of claim 1 wherein:
said distribution of said content includes distributing content from a first consumer network to a second consumer network.

6. The system of claim 1 wherein:
said distribution of said content includes delivering a first portion of said content from a first content source, delivering a second portion of said content from a second content source, and assembling said first portion and said second portion at a first consumer network.

7. The system of claim 6 wherein:
said first content source is said network storage device and said second content source is a second consumer network.

8. The system of claim 6 wherein:
said first portion is video and said second portion is video.

9. The system of claim 6 wherein:
said first portion is even video frames and said second portion is odd video frames.

10. The system of claim 1 wherein:
said distribution of said content includes delivering a first portion of said content prior to viewing said content and streaming a second portion of said content in realtime when said content is viewed.

11. The system of claim 10 wherein:
said second portion of said content is audio.

12. The system of claim 10 wherein:
said second portion of said content is a component of a video signal.

13. The system of claim 1 wherein:
said distribution of said content is performed in response to distribution network performance.

14. The system of claim 13 wherein:
said distribution network performance is determined based on bandwidth to one of said consumer networks.

15. The system of claim 14 wherein:
content is delivered prior to viewing or for realtime viewing in response to said bandwidth to one of said consumer networks.

16. The system of claim 14 wherein:
the number of active content delivery sessions to one of said consumer networks is determined based on said bandwidth.

17. The system of claim 1 wherein:
said distribution network includes at least one of DSL, cable and wireless networks.

18. The system of claim 1 wherein:
said content is associated with a content profile and said consumer network is associated with a consumer profile, said content being distributed to said consumer network in response to said content profile and said consumer profile.

19. The system of claim 18 wherein:
said consumer network includes a device for displaying said content, said content being distributed to said consumer network in response to said content profile, said consumer profile and said device profile.
